(19) United States
(12) Patent Application Publication
(10) Pub. No.: US 2001/0016248 A1
(43) Pub. Date: Aug. 23, 2001

(54) PRINTING SHEET

(76) Inventors: GEORGE E. ALDERFER, EXPORT, PA (US); CHARLES T. HILL, NEW BRIGHTON, PA (US); WILLIAM A. KEIM, MARRYSVILLE, OH (US); RICHARD A. SCHWARZ, AKRON, OH (US); BULENT E. YOLDAS, PITTSBURGH, PA (US)

Correspondence Address: LAW DEPARTMENT, INTELLECTUAL PROPERTY, PPG INDUSTRIES INC, ONE PPG PLACE 39 SOUTH, PITTSBURGH, PA, 15272

(21) Appl. No.: 08/927,844

(22) Filed: Sep. 11, 1997

Related U.S. Application Data
(62) Division of application No. 08/573,081, filed on Dec. 15, 1995.
(60) Provisional application No. 60/002,042, filed on Aug. 8, 1995.

(51) Int. Cl. B41M 5/00

(52) U.S. Cl. 428/195; 428/206; 428/211

(57) ABSTRACT

Printing sheets comprising microporous material or compressed microporous material having an ink-receptive layer joined to at least one side of the microporous material or compressed microporous material are particularly suited for ink jet printing. Preferably the ink receptive layer comprises hydrated aluminum oxide, and binder comprising water-soluble hydroxypropyl cellulose and water-soluble poly(vinyl alcohol).

This application claims the benefit of U.S. Provisional Application Ser. No. 60/002,042, filed Aug. 8, 1995.

Printing sheets comprising microporous material or compressed microporous material having an ink-receptive layer joined to at least one side of the microporous material or compressed microporous material are particularly suited for ink jet printing.

One embodiment of the invention is an article comprising: (a) a sheet of microporous material having generally opposing sides, the microporous material on a coating-free, printing ink-free, and impregnant-free basis comprising: (1) a matrix consisting essentially of substantially water-insoluble thermoplastic organic polymer, (2) finely divided substantially water-insoluble filler particles, the filler particles being distributed throughout the matrix and constituting from 40 to 90 percent by weight of the microporous material, and (3) a network of interconnecting pores communicating substantially throughout the microporous material, the pores constituting from 35 to 95 percent by volume of the microporous material; and (b) an ink-receptive layer joined to at least one side of the microporous material, the ink receptive layer comprising hydrated aluminum oxide.

Microporous materials comprising thermoplastic organic polymer, large proportions of particles, and large void volumes are known and have many valuable properties. Examples of such microporous materials, processes for making such microporous materials, and their properties are described in U.S. Pat. Nos. 2,772,322; 3,351,495; 3,696,061; 3,725,520; 3,862,030; 3,903,234; 3,967,978; 4,024,323; 4,102,746; 4,169,014; 4,210,709; 4,226,926; 4,237,083; 4,335,193; 4,350,655; 4,472,328; 4,585,604; 4,613,643; 4,681,750; 4,791,144; 4,833,172; 4,861,644; 4,892,779; 4,927,802; 4,872,779; 4,927,802; 4,937,115; 4,957,787; 4,959,208; 5,032,450; 5,035,886; 5,071,645; 5,047,283; and 5,114,438, 5,196,262, 5,236,391, and in International Publication No. WO 92/06577.

The matrix of the microporous material consists essentially of substantially water-insoluble thermoplastic organic polymer. The numbers and kinds of such polymers suitable for use of the matrix are enormous. In general, substantially any substantially water-insoluble thermoplastic organic polymer which can be extruded, calendered, pressed, or rolled into film, sheet, strip, or web may be used. The polymer may be a single polymer or it may be a mixture of polymers. The polymers may be homopolymers, copolymers, random copolymers, block copolymers, graft copolymers, atactic polymers, isotactic polymers, syndiotactic polymers, linear polymers, or branched polymers. When mixtures of polymers are used, the mixture may be homogeneous or it may comprise two or more polymeric phases. Examples of classes of suitable substantially water-insoluble thermoplastic organic polymers include the thermoplastic polyolefins, poly(halo-substituted olefins), polyesters, polyamides, polyurethanes, polyureas, poly(vinyl halides), poly(vinylidene halides), polystyrenes, poly(vinyl esters), polycarbonates, polyethers, polysulfides, polyimides, polysilanes, polysiloxanes, polycaprolactones, polyacrylates, and polymethacrylates. Hybrid classes exemplified by the thermoplastic poly(urethane-ureas), poly(ester-amides), poly(silane-siloxanes), and poly(ether-esters) are within contemplation. Examples of suitable substantially water-insoluble thermoplastic organic polymers include thermoplastic high density polyethylene, low density polyethylene, ultrahigh molecular weight polyethylene, polypropylene (atactic, isotactic, or syndiotatic as the case may be), poly(vinyl chloride), polytetrafluoroethylene, copolymers of ethylene and acrylic acid, copolymers of ethylene and methacrylic acid, poly(vinylidene chloride), copolymers of vinylidene chloride and vinyl acetate, copolymers of vinylidene chloride and vinyl chloride, copolymers of ethylene and propylene, copolymers of ethylene and butene, poly(vinyl acetate), polystyrene, poly(omega-aminoundecanoic acid) poly(hexamethylene adipamide), poly(epsilon-caprolactam), and poly(methyl methacrylate). These listings are by no means exhaustive, but are intended for purposes of illustration. The preferred substantially water-insoluble thermoplastic organic polymers comprise poly(vinyl chloride), copolymers of vinyl chloride, or mixtures thereof; or they comprise essentially linear ultrahigh molecular weight polyolefin which is essentially linear ultrahigh molecular weight polyethylene having an intrinsic viscosity of at least 10 deciliters/gram, essentially linear ultrahigh molecular weight polypropylene having an intrinsic viscosity of at least 6 deciliters/gram, or a mixture thereof. Essentially linear ultrahigh molecular weight polyethylene having an intrinsic viscosity of at least 18 deciliters/gram is especially preferred.

Inasmuch as ultrahigh molecular weight (UHMW) polyolefin is not a thermoset polymer having an infinite molecular weight, it is technically classified as a thermoplastic. However, because the molecules are essentially very long chains, UHMW polyolefin, and especially UHMW polyethylene, softens when heated but does not flow as a molten liquid in a normal thermoplastic manner. The very long chains and the peculiar properties they provide to UHMW polyolefin are believed to contribute in large measure to the desirable properties of microporous materials made using this polymer.

As indicated earlier, the intrinsic viscosity of the UHMW polyethylene is at least 10 deciliters/gram. Usually the intrinsic viscosity is at least 14 deciliters/gram. Often the intrinsic viscosity is at least 18 deciliters/gram. In many cases the intrinsic viscosity is at least 19 deciliters/gram. Although there is no particular restriction on the upper limit of the intrinsic viscosity, the intrinsic viscosity is frequently in the range of from 10 to 39 deciliters/gram. The intrinsic viscosity is often in the range of from 14 to 39 deciliters/gram. In most cases the intrinsic viscosity is in the range of from 18 to 39 deciliters/gram. An intrinsic viscosity in the range of from 18 to 32 deciliters/gram is preferred.

Also as indicated earlier the intrinsic viscosity of the UHMW polypropylene is at least 6 deciliters/gram. In many cases the intrinsic viscosity is at least 7 deciliters/gram. Although there is no particular restriction on the upper limit of the intrinsic viscosity, the intrinsic viscosity is often in the range of from 6 to 18 deciliters/gram. An intrinsic viscosity in the range of from 7 to 16 deciliters/gram is preferred.

As used herein, intrinsic viscosity is determined by extrapolating to zero concentration the reduced viscosities or the inherent viscosities of several dilute solutions of the UHMW polyolefin where the solvent is freshly distilled decahydronaphthalene to which 0.2 percent by weight, 3,5-di-tert-butyl-4-hydroxyhydrocinnamic acid, neopentanetetrayl ester [CAS Registry No. 6683-19-8] has been added. The reduced viscosities or the inherent viscosities of the UHMW polyolefin are ascertained from relative viscosities obtained at 135° C. using an Ubbelohde No. 1 viscometer in accordance with the general procedures of ASTM D 4020-81, except that several dilute solutions of differing concentration are employed.

The nominal molecular weight of UHMW polyethylene is empirically related to the intrinsic viscosity of the polymer according to the equation:

M=5.37×10⁴ [η]^{1.37}

where M is the nominal molecular weight and [η] is the intrinsic viscosity of the UHMW polyethylene expressed in deciliters/gram. Similarly, the nominal molecular weight of UHMW polypropylene is empirically related to the intrinsic viscosity of the polymer according to the equation:

M=8.88×10⁴ [η]^{1.25}

where M is the nominal molecular weight and [η] is the intrinsic viscosity of the UHMW polypropylene expressed in deciliters/gram.

The essentially linear ultrahigh molecular weight polypropylene is most frequently essentially linear ultrahigh molecular weight isotactic polypropylene. Often the degree of isotacicity of such polymer is at least 95 percent, while preferably it is at least 98 percent.

When used, sufficient UHMW polyolefin should be present in the matrix to provide its properties to the microporous material. Other thermoplastic organic polymer may also be present in the matrix so long as its presence does not materially affect the properties of the microporous material in an adverse manner. The amount of the other thermoplastic polymer which may be present depends upon the nature of such polymer. In general, a greater amount of other thermoplastic organic polymer may be used if the molecular structure contains little branching, few long sidechains, and few bulky side groups, than when there is a large amount of branching, many long sidechains, or many bulky side groups. For this reason, the preferred thermoplastic organic polymers which may optionally be present are low density polyethylene, high density polyethylene, poly(tetrafluoroethylene), polypropylene, copolymers of ethylene and propylene, copolymers of ethylene and acrylic acid, and copolymers of ethylene and methacrylic acid. If desired, all or a portion of the carboxyl groups of carboxyl-containing copolymers may be neutralized with sodium, zinc, or the like. It is our experience that usually at least about one percent UHMW polyolefin, based on the weight of the matrix, will provide the desired properties to the microporous material. At least 1 percent UHMW polyolefin by weight of the matrix is commonly used. Often at least 3 percent by weight of the matrix is UHMW polyolefin. In many cases at least 10 percent by weight of the matrix is UHMW polyolefin. Frequently at least 50 percent by weight of the matrix is UHMW polyolefin. In many instances at least 60 percent by weight of the matrix is UHMW polyolefin. Sometimes at least 70 percent by weight of the matrix is UHMW polyolefin. In some cases the other thermoplastic organic polymer is substantially absent. In many instances the UHMW polyolefin constitutes from 1 to 90 percent by weight of the matrix. Often the UHMW polyolefin constitutes from 35 to 85 percent by weight of the matrix. Preferably the UHMW polyolefin constitutes from 40 to 80 percent by weight of the matrix. In some instances the UHMW polyolefin preferably constitutes from 40 to 60 percent by weight of the matrix.

In a preferred embodiment the matrix comprises a mixture of substantially linear ultrahigh molecular weight polyethylene having an intrinsic viscosity of at least 10 deciliters/gram and lower molecular weight polyethylene having an ASTM D 1238-86 Condition E melt index of less than 50 grams/10 minutes and an ASTM D 1238-86 Condition F melt index of at least 0.1 gram/10 minutes. The nominal molecular weight of the lower molecular weight polyethylene (LMWPE) is lower than that of the UHMW polyethylene. LMWPE is thermoplastic and many different types are known. One method of classification is by density, expressed in grams/cubic centimeter and rounded to the nearest thousandth, in accordance with ASTM D 1248-84 (Reapproved 1989):

TABLE 1

| Type | Abbreviation | Density, g/cm³ |
|---|---|---|
| Low Density Polyethylene | LDPE | 0.910-0.925 |
| Medium Density Polyethylene | MDPE | 0.926-0.940 |
| High Density Polyethylene | HDPE | 0.941-0.965 |

Any or all of these polyethylenes may be used as the LMWPE in the present invention. HDPE, however, is preferred because it ordinarily tends to be more linear than MDPE or LDPE.

The ASTM D 1238-86 Condition E (that is, 190° C. and 2.16 kilogram load) melt index of the LMWPE is less than 50 grams/10 minutes. Often the Condition E melt index is less than 25 grams/10 minutes. Preferably the Condition E melt index is less than 15 grams/10 minutes.

The ASTM D 1238-86 Condition F (that is, 190° C. and 21.6 kilogram load) melt index of the LMWPE is at least 0.1 gram/10 minutes. In many cases the Condition F melt index is at least 0.5 gram/10 minutes. Preferably the Condition F melt index is at least 1.0 gram/10 minutes.

It is especially preferred that the UHMW polyethylene constitute at least one percent by weight of the matrix and that the UHMW polyethylene and the LMWPE together constitute substantially 100 percent by weight of the polymer of the matrix.

The finely divided substantially water-insoluble filler particles constitute from 40 to 90 percent by weight of the microporous material. Frequently such filler particles constitute from 40 to 85 percent by weight of the microporous material. Often the finely divided substantially water-insoluble filler particles constitute from 50 to 90 percent by weight of the microporous material. In many cases the finely divided substantially water-insoluble filler particles constitute from 50 to 85 percent by weight of the microporous material. From 50 percent to 80 percent by weight is preferred. In many instances from 60 percent to 80 percent by weight is preferred.

Preferably at least 50 percent by weight of the finely divided substantially water-insoluble filler particles are finely divided substantially water-insoluble siliceous filler particles. In many cases at least 65 percent by weight of the finely divided substantially water-insoluble filler particles are siliceous. Often at least 75 percent by weight of the finely divided substantially water-insoluble filler particles are siliceous. Frequently at least 85 percent by weight of the finely divided substantially water-insoluble filler particles are siliceous. In many instances all of the finely divided substantially water-insoluble filler particles are siliceous.

As present in the microporous material, the finely divided substantially water-insoluble siliceous particles may be in the form of ultimate particles, aggregates of ultimate particles, or a combination of both. In most cases, at least 90 percent by weight of the siliceous particles used in preparing the microporous material have gross particle sizes in the range of from 5 to 40 micrometers as determined by use of a Multisizer II Coulter counter (Coulter Electronics, Inc.) according to ASTM C 690-86 but modified by stirring the amorphous precipitated silica for 10 minutes in Isoton II electrolyte (Curtin Matheson Scientific, Inc.) using a four blade, 4.5 centimeter diameter propeller stirrer. Preferably at least 90 percent by weight of the siliceous particles have gross particle sizes in the range of from 10 to 30 micrometers. It is expected that the sizes of filler agglomerates may be reduced during processing of the ingredients to prepare the microporous material. Accordingly, the distribution of gross particle sizes in the microporous material may be smaller than in the raw siliceous filler itself.

Examples of suitable siliceous particles include particles of silica, mica, montmorillonite, kaolinite, asbestos, talc, diatomaceous earth, vermiculite, natural and synthetic zeolites, cement, calcium silicate, aluminum silicate, sodium aluminum silicate, aluminum polysilicate, alumina silica gels, and glass particles. Silica and the clays are the preferred siliceous particles. Of the silicas, precipitated silica, silica gel, or fumed silica is most often used. Preferably precipitated silica is used.

In lieu of or in addition to the siliceous particles, finely divided substantially water-insoluble non-siliceous filler particles may be employed. Examples of such optional non-siliceous filler particles include particles of titanium oxide, iron oxide, copper oxide, zinc oxide, antimony oxide, zirconia, magnesia, alumina, molybdenum disulfide, zinc sulfide, barium sulfate, strontium sulfate, calcium carbonate, magnesium carbonate, magnesium hydroxide, and finely divided substantially water-insoluble flame retardant filler particles such as particles of ethylenebis(tetra-bromophthalimide), octabromodiphenyl oxide, decabromodiphenyl oxide, and ethylenebisdibromonorbornane dicarboximide.

As present in the microporous material, the finely divided substantially water-insoluble non-siliceous filler particles may be in the form of ultimate particles, aggregates of ultimate particles, or a combination of both. In most cases, at least 75 percent by weight of the non-siliceous filler particles used in preparing the microporous material have gross particle sizes in the range of from 0.1 to 40 micrometers as determined by use of a Micromeretics Sedigraph 5000-D (Micromeretics Instrument Corp.) in accordance with the accompanying operating manual. The preferred ranges vary from filler to filler. For example, it is preferred that at least 75 percent by weight of antimony oxide particles be in the range of from 0.1 to 3 micrometers, whereas it is preferred that at least 75 percent by weight of barium sulfate particles be in the range of from 1 to 25 micrometers. It is expected that the sizes of filler agglomerates may be reduced during processing of the ingredients to prepare the microporous material. Therefore, the distribution of gross particle sizes in the microporous material may be smaller than in the raw non-siliceous filler itself.

The particularly preferred finely divided substantially water-insoluble siliceous filler particles are precipitated silica particles. Although both are silicas, it is important to distinguish precipitated silica from silica gel inasmuch as these different materials have different properties. Reference in this regard is made to R. K. Iler, The Chemistry of Silica, John Wiley & Sons, New York (1979), Library of Congress Catalog No. QD 181.S6144. Note especially pages 15-29, 172-176, 218-233, 364-365, 462-465, 554-564, and 578-579. Silica gel is usually produced commercially at low pH by acidifying an aqueous solution of a soluble metal silicate, typically sodium silicate, with acid. The acid employed is generally a strong mineral acid such as sulfuric acid or hydrochloric acid although carbon dioxide is sometimes used. Inasmuch as there is essentially no difference in density between the gel phase and the surrounding liquid phase while the viscosity is low, the gel phase does not settle out, that is to say, it does not precipitate. Silica gel, then, may be described as a nonprecipitated, coherent, rigid, three-dimensional network of contiguous particles of colloidal amorphous silica. The state of subdivision ranges from large, solid masses to submicroscopic particles, and the degree of hydration from almost anhydrous silica to soft gelatinous masses containing on the order of 100 parts of water per part of silica by weight, although the highly hydrated forms are only rarely used in the present invention.

Precipitated silica is usually produced commercially by combining an aqueous solution of a soluble metal silicate, ordinarily alkali metal silicate such as sodium silicate, and an acid so that colloidal particles will grow in weakly alkaline solution and be coagulated by the alkali metal ions of the resulting soluble alkali metal salt. Various acids may be used, including the mineral acids and carbon dioxide. In the absence of a coagulant, silica is not precipitated from solution at any pH. The coagulant used to effect precipitation may be the soluble alkali metal salt produced during formation of the colloidal silica particles, it may be added electrolyte such as a soluble inorganic or organic salt, or it may be a combination of both.

Precipitated silica, then, may be described as precipitated aggregates of ultimate particles of colloidal amorphous silica that have not at any point existed as macroscopic gel during the preparation. The sizes of the aggregates and the degree of hydration may vary widely.

Precipitated silica powders differ from silica gels that have been pulverized in ordinarily having a more open structure, that is, a higher specific pore volume. However, the specific surface area of precipitated silica as measured by the Brunauer, Emmet, Teller (BET) method using nitrogen as the adsorbate, is often lower than that of silica gel.

Many different precipitated silicas may be employed in the present invention, but the preferred precipitated silicas are those obtained by precipitation from an aqueous solution of sodium silicate using a suitable acid such as sulfuric acid, hydrochloric acid, or carbon dioxide. Such precipitated silicas are themselves known and exemplary processes for producing them are described in detail in U.S. Pat. Nos. 2,657,149; 2,940,830; 4,681,750 and 5,094,829.

In the case of the preferred filler, precipitated silica, the average ultimate particle size (irrespective of whether or not the ultimate particles are agglomerated) is less than 0.1 micrometer as determined by transmission electron microscopy. Often the average ultimate particle size is less than 0.05 micrometer. Preferably the average ultimate particle size of the precipitated silica is less than 0.03 micrometer.

Minor amounts, usually less than 5 percent by weight, of other materials used in processing such as lubricant, processing plasticizer, organic extraction liquid, water, and the like, may optionally also be present. Yet other materials introduced for particular purposes may optionally be present in the microporous material in small amounts, usually less than 15 percent by weight. Examples of such materials include antioxidants, ultraviolet light absorbers, reinforcing fibers such as chopped glass fiber strand, dyes, pigments, and the like. The balance of the microporous material, exclusive of filler and any coating, printing ink, or impregnant applied for one or more special purposes is essentially the thermoplastic organic polymer.

On a coating-free, printing ink free, and impregnant-free basis, pores constitute from 35 to 80 percent by volume of the microporous material when made by the above-described process. In many cases the pores constitute from 60 to 75 percent by volume of the microporous material. As used herein and in the claims, the porosity (also known as void volume) of the microporous material, expressed as percent by volume, is determined according to the equation:

Porosity=100[1−d₁/d₂]

where d₁ is the density of the sample which is determined from the sample weight and the sample volume as ascertained from measurements of the sample dimensions and d₂ is the density of the solid portion of the sample which is determined from the sample weight and the volume of the solid portion of the sample. The volume of the solid portion of the same is determined using a Quantachrome stereopycnometer (Quantachrome Corp.) in accordance with the accompanying operating manual.

The volume average diameter of the pores of the microporous material is determined by mercury porosimetry using an Autoscan mercury porosimeter (Quantachrome Corp.) in accordance with the accompanying operating manual. The volume average pore radius for a single scan is automatically determined by the porosimeter. In operating the porosimeter, a scan is made in the high pressure range (from about 138 kilopascals absolute to about 227 megapascals absolute). If about 2 percent or less of the total intruded volume occurs at the low end (from about 138 to about 250 kilopascals absolute) of the high pressure range, the volume average pore diameter is taken as twice the volume average pore radius determined by the porosimeter. Otherwise, an additional scan is made in the low pressure range (from about 7 to about 165 kilopascals absolute) and the volume average pore diameter is calculated according to the equation:

$$d = \frac{2 [ \frac{{v}_{1} {r}_{1}}{{w}_{1} } + \frac{{v}_{2} {r}_{2}}{{w}_{2} } ]}{[ \frac{{v}_{1}}{{w}_{1}} + \frac{{v}_{2}}{{w}_{2}} ]}$$

where d is the volume average pore diameter, v₁ is the total volume of mercury intruded in the high pressure range, v₂ is the total volume of mercury intruded in the low pressure range, r₁ is the volume average pore radius determined from the high pressure scan, r₂ is the volume average pore radius determined from the low pressure scan, w₁ is the weight of the sample subjected to the high pressure scan, and w₂ is the weight of the sample subjected to the low pressure scan. Generally on a coating-free, printing ink-free, impregnant-free, and pre-bonding basis the volume average diameter of the pores is in the range of from 0.02 to 0.5 micrometer. Very often the volume average diameter of the pores is in the range of from 0.04 to 0.3 micrometer. From 0.05 to 0.25 micrometer is preferred.

In the course of determining the volume average pore diameter by the above procedure, the maximum pore radius detected is sometimes noted. This is taken from the low pressure range scan if run; otherwise it is taken from the high pressure range scan. The maximum pore diameter is twice the maximum pore radius.

Inasmuch as some coating processes, printing processes, impregnation processes and bonding processes result in filling at least some of the pores of the microporous material and since some of these processes irreversibly compress the microporous material, the parameters in respect of porosity, volume average diameter of the pores, and maximum pore diameter are determined for the microporous material prior to application of one or more of these processes.

Many processes are known for producing the microporous materials which may be employed in the present invention. Such processes are exemplified by those described in the patents and international patent publication earlier referenced.

Preferably filler particles, thermoplastic organic polymer powder, processing plasticizer and minor amounts of lubricant and antioxidant are mixed until a substantially uniform mixture is obtained. The weight ratio of filler to polymer powder employed in forming the mixture is essentially the same as that of the microporous material to be produced. The mixture, together with additional processing plasticizer, is introduced to the heated barrel of a screw extruder. Attached to the extruder is a sheeting die. A continuous sheet formed by the die is forwarded without drawing to a pair of heated calender rolls acting cooperatively to form continuous sheet of lesser thickness than the continuous sheet exiting from the die. The continuous sheet from the calender then passes to a first extraction zone where the processing plasticizer is substantially removed by extraction with an organic liquid which is a good solvent for the processing plasticizer, a poor solvent for the organic polymer, and more volatile than the processing plasticizer. Usually, but not necessarily, both the processing plasticizer and the organic extraction liquid are substantially immiscible with water. The continuous sheet then passes to a second extraction zone where the residual organic extraction liquid is substantially removed by steam and/or water. The continuous sheet is then passed through a forced air dryer for substantial removal of residual water and remaining residual organic extraction liquid. From the dryer the continuous sheet, which is microporous material, is passed to a take-up roll.

The processing plasticizer has little solvating effect on the thermoplastic organic polymer at 60° C., only a moderate solvating effect at elevated temperatures on the order of 100° C., and a significant solvating effect at elevated temperatures on the order of 200° C. It is a liquid at room temperature and usually it is processing oil such as paraffinic oil, naphthenic oil, or aromatic oil. Suitable processing oils include those meeting the requirements of ASTM D 2226-82, Types 103 and 104. Preferred are oils which have a pour point of less than 22° C. according to ASTM D 97-66 (Reapproved 1978). Particularly preferred are oils having a pour point of less than 10° C. Examples of suitable oils include Shellflex® 412 and Shellflex® 371 oil (Shell Oil Co.) which are solvent refined and hydrotreated oils derived from naphthenic crude. Further examples of suitable oils include ARCOprime® 400 oil (Atlantic Richfield Co.) and Kaydol® oil (Witco Corp.) which are white mineral oils. It is expected that other materials, including the phthalate ester plasticizers such as dibutyl phthalate, bis(2-ethylhexyl) phthalate, diisodecyl phthalate, dicyclohexyl phthalate, butyl benzyl phthalate, and ditridecyl phthalate will function satisfactorily as processing plasticizers.

There are many organic extraction liquids that can be used. Examples of suitable organic extraction liquids include 1,1,2-trichloroethylene, perchloroethylene, 1,2-dichloroethane, 1,1,1-trichloroethane, 1,1,2-trichloroethane, methylene chloride, chloroform, 1,1,2-trichloro-1,2,2-trifluoroethane, isopropyl alcohol, diethyl ether, acetone, hexane, heptane, and toluene.

In the above described process for producing microporous material, extrusion and calendering are facilitated when the substantially water-insoluble filler particles carry much of the processing plasticizer. The capacity of the filler particles to absorb and hold the processing plasticizer is a function of the surface area of the filler. It is therefore preferred that the filler have a high surface area. High surface area fillers are materials of very small particle size, materials having a high degree of porosity or materials exhibiting both characteristics. Usually the surface area of at least the siliceous filler particles is in the range of from 20 to 400 square meters per gram as determined by the Brunauer, Emmett, Teller (BET) method according to ASTM C 819-77 using nitrogen as the adsorbate but modified by outgassing the system and the sample for one hour at 130° C. Preferably the surface area is in the range of from 25 to 350 square meters per gram. Preferably, but not necessarily, the surface area of any non-siliceous filler particles used is also in at least one of these ranges.

Inasmuch as it is desirable to essentially retain the filler in the microporous material, it is preferred that the substantially water-insoluble filler particles be substantially insoluble in the processing plasticizer and substantially insoluble in the organic extraction liquid when microporous material is produced by the above process.

The residual processing plasticizer content is usually less than 10 percent by weight of the microporous sheet and this may be reduced even further by additional extractions using the same or a different organic extraction liquid. Often the residual processing plasticizer content is less than 5 percent by weight of the microporous sheet and this may be reduced even further by additional extractions.

On a coating-free, printing ink free, impregnant-free, and pre-bonding basis, pores constitute from 35 to 80 percent by volume of the microporous material when made by the above-described process. In many cases the pores constitute from 60 to 75 percent by volume of the microporous material.

The volume average diameter of the pores of the microporous material when made by the above-described process, is usually in the range of from 0.02 to 0.5 micrometer on a coating-free, printing ink-free, impregnant-free, and pre-bonding basis. Frequently the average diameter of the pores is in the range of from 0.04 to 0.3 micrometer. From 0.05 to 0.25 micrometer is preferred.

Microporous material may also be produced according to the general principles and procedures of U.S. Pat. Nos. 2,772,322; 3,696,061; and/or 3,862,030 These principles and procedures are particularly applicable where the polymer of the matrix is or is predominately poly(vinyl chloride) or a copolymer containing a large proportion of polymerized vinyl chloride.

The ink receptive layer joined to at least one side of the microporous material comprises hydrated aluminum oxide. The hydrated aluminum oxide may be amorphous or it may be crystalline. If crystalline, it may be of any crystalline structure. Examples of these include boehmite, γ-alumina, δ-alumina, and θ-alumina. Of these, boehmite is preferred.

As present in the ink receptive layer joined to at least one side of the microporous material, the hydrated aluminum oxide particles are colloidal fine particles or aggregates of colloidal fine particles.

The ink receptive layer is usually joined to the microporous material surface by coating the surface of the microporous material with a coating composition comprising a sol of colloidal hydrated aluminum oxide, and substantially removing the liquid dispersion medium from the wet coating. The liquid dispersion medium is usually removed by drying.

Sols of colloidal hydrated aluminum oxide are dispersions of colloidal hydrated aluminum oxide (the dispersed phase) in liquid (the dispersion medium). The liquid dispersion medium usually, but not necessarily, comprises water as the chief constituent. Such sols and methods for their preparation are themselves well known. Their preparation and properties are described by B. E. Yoldas in The American Ceramic Society Bulletin, Vol. 54, No. 3, (March 1975), pages 289-290, in Journal of Applied Chemical Biotechnology, Vol. 23 (1973), pages 803-809, and in Journal of Materials Science, Vol. 10 (1975), pages 1856-1860, and in U.S. Pat. Nos. 3,944,658; 4,879,166; 5,104,730, 5,264,279, and 5,354,634. Briefly, aluminum isopropoxide or aluminum secondary-butoxide are hydrolyzed in an excess of water with vigorous agitation at from 75 C to 80° C. to form a slurry of aluminum monohydroxide. The aluminum monohydroxide is then peptized at temperatures of at least 80° C. with an acid to form a clear hydrated aluminum oxide sol. The acid employed is noncomplexing with aluminum, and it has sufficient strength to produce the required charge effect at low concentration. Nitric acid, hydrochloric acid, perchloric acid, acetic acid, chloroacetic acid, and formic acid meet these requirements. The acid concentration is usually in the range of from 0.03 to 0.1 mole of acid per mole of aluminum alkoxide. The amount of hydrated aluminum oxide present in the sol can vary widely, but usually it constitutes from 1 to 20 percent by weight of the sol. Often the hydrated aluminum oxide constitutes from 3 to 18 percent by weight of the sol. Preferably the hydrated aluminum oxide constitutes from 8 to 12 percent by weight of the sol.

The coating composition may consist only of hydrated aluminum oxide sol, but most often water-soluble binder is also present.

The coating composition may comprise the sol of hydrated aluminum oxide as formed, or the sol may be diluted with further liquid or the sol may be concentrated by removing some of the liquid. In most instances the coating composition comprises from 0 to 20 percent by weight hydrated aluminum oxide. Often the coating composition comprises from 1 to 20 percent by weight hydrated aluminum oxide. Frequently the coating composition comprises from 3 to 18 percent by weight hydrated aluminum oxide. From 8 to 12 percent by weight is preferred.

The coating composition may consist only of water-soluble binder and aqueous solvent therefor, but most often hydrated aluminum oxide is also present.

The water-soluble binder is a water-soluble organic polymer or a mixture of water-soluble organic polymers. Examples of water-soluble polymers include water-soluble cellulose ether, water-soluble poly(vinyl alcohol), water-soluble poly(vinyl alkyl ether), water-soluble poly (vinyl pyrrolidone), water-soluble poly(ethylenimine), water-soluble vinyl pyrrolidone/vinyl acetate copolymer, water-soluble quaternized vinyl pyrrolidone/dialkylaminoethyl methacrylate copolymer, and mixtures thereof.

Water-soluble cellulose ether is a preferred water-soluble binder material. Many of the water-soluble cellulose ethers are also excellent water retention agents. water-soluble cellulose ether may be used alone or in admixture with one or more other water-soluble organic polymers. Examples of the water-soluble cellulose ethers include water-soluble methylcellulose [CAS 9004-67-5], water-soluble carboxymethylcellulose, water-soluble sodium carboxymethylcellulose [CAS 9004-32-4], water-soluble ethylmethylcellulose, water-soluble hydroxyethylmethylcellulose [CAS 9032-42-2], water-soluble hydroxypropylmethylcellulose [CAS 9004-65-3], water-soluble hydroxyethylcellulose [CAS 9004-62-0], water-soluble ethylhydroxyethylcellulose, water-soluble sodium carboxymethylhydroxyethylcellulose, water-soluble hydroxypropylcellulose [CAS 9004-64-2], water-soluble hydroxybutylcellulose [CAS 37208-08-5], and water-soluble hydroxybutylmethylcellulose [CAS 9041-56-9]. Water-soluble hydroxypropylcellulose is preferred.

Water-soluble hydroxypropyl cellulose is a known material and is available commercially in several different average molecular weights. The weight average molecular weight of the water-soluble hydroxypropyl cellulose used in the present invention can vary widely, but usually it is in the range of from 100,000 to 1,000,000. Often the weight average molecular weight is in the range of from 100,000 to 500,000. From 200,000 to 400,000 is preferred. Two or more water-soluble hydroxypropyl celluloses having different average molecular weights may be admixed to obtain a water-soluble hydroxypropyl cellulose having a differing average molecular weight.

When used, the amount of water-soluble cellulose ether present in the binder may vary considerably. In most instances water-soluble cellulose ether, when used, constitutes from 1 to 100 percent by weight of the binder. Frequently water-soluble cellulose ether, when used, constitutes from 25 to 85 percent by weight of the binder. Preferably water-soluble cellulose ether, when used, constitutes from 45 to 75 percent by weight of the binder.

Another preferred water-soluble binder material is water-soluble poly(vinyl alcohol) [CAS 9002-89-5]. It may be used alone or in admixture with one or more other water-soluble organic polymers.

Water-soluble poly(vinyl alcohol) may be broadly classified as one of two types. The first type is fully hydrolyzed poly(vinyl alcohol) in which less than 1.5 mole percent acetate groups are left on the molecule. The second type is partially hydrolyzed poly(vinyl alcohol) in which from 1.5 to as much as 20 mole percent acetate groups are left on the molecule. The binder may comprise either type or a mixture of both. The partially hydrolyzed poly(vinyl alcohol) is preferred.

When used, the amount of water-soluble poly(vinyl alcohol) present in the binder may vary considerably. In most instances water-soluble poly(vinyl alcohol), when used, constitutes from 1 to 100 percent by weight of the binder. Frequently water-soluble poly(vinyl alcohol), when used, constitutes from 15 to 75 percent by weight of the binder. Preferably water-soluble poly(vinyl alcohol), when used, constitutes from 25 to 55 percent by weight of the binder.

Preferably, the binder comprises both water-soluble cellulose ether and water-soluble poly(vinyl alcohol). The amounts of these materials in the binder may vary widely. Generally the water-soluble cellulose ether constitutes from 1 to 99 percent by weight of the binder and the water-soluble poly(vinyl alcohol) constitutes from 1 to 99 percent by weight of the binder. Often the water-soluble cellulose ether constitutes from 25 to 85 percent by weight of the binder and the water-soluble poly(vinyl alcohol) constitutes from 15 to 75 percent by weight of the binder. Preferably the water-soluble cellulose ether constitutes from 45 to 75 percent by weight of the binder and the water-soluble poly(vinyl alcohol) constitutes from 25 to 55 percent by weight of the binder.

The coating composition usually comprises from 0 to 20 percent by weight binder. Often the coating composition comprises from 0.5 to 20 percent by weight binder. In many instances the coating composition comprises from 1 to 12 percent by weight binder. From 2 to 8 percent by weight is preferred.

When the coating composition comprises water-soluble binder, it also comprises aqueous solvent for the water-soluble binder.

In most instances the aqueous solvent for the water-soluble binder is water. Organic cosolvents miscible with water may optionally be present when desired.

When aqueous solvent is used, the coating composition frequently comprises from 80 to 99 percent by weight aqueous solvent. Often the coating composition comprises from 80 to 95 percent by weight aqueous solvent. Preferably the coating composition comprises from 80 to 90 percent by weight aqueous solvent.

Aqueous solvent is substantially absent from the final coating. Therefore, the coating generally comprises from 0 to 100 percent by weight binder. Often the coating comprises from 2 to 95 percent by weight binder. Frequently the coating comprises from 5 to 80 percent by weight binder. From 14 to 50 percent by weight binder is preferred.

The coating comprises from 0 to 100 percent by weight hydrated aluminum oxide. Often the coating comprises from 5 to 98 percent by weight hydrated aluminum oxide. Frequently the coating comprises from 20 to 95 percent by weight hydrated aluminum oxide. From 50 to 86 percent by weight is preferred.

Dyes, tints, coloring pigments, ultraviolet light absorbers, and antioxidants are further examples of other materials which may optionally be present. This listing of optional ingredients discussed above is by no means exhaustive. Other ingredients may be employed in their customary amounts for their customary purposes so long as they do not materially interfere with good coatings practice.

Coating compositions containing water-soluble binder are usually prepared by simply admixing the various ingredients. Although the mixing is usually accomplished at room temperature, elevated temperatures are sometimes used. The maximum temperature which is usable depends upon the heat stability of the ingredients.

The coating compositions are generally applied to microporous material using substantially any technique known to the art. These include spraying, curtain coating, dipping, rod coating, blade coating, roller application, size press, printing, brushing, drawing, and extrusion. The coating is then formed by removing the aqueous solvent from the applied coating composition. This may be accomplished by any conventional drying technique. Coating composition may be applied once or a multiplicity of times. When the coating composition is applied a multiplicity of times, the applied coating is usually but not necessarily dried, either partially or totally, between coating applications.

After the coating composition has been applied to the microporous sheet but before the coating composition has been dried to form the coating, the coated microporous sheet may be compressed to permanently reduce the thickness thereof so that the thickness ratio is in the range of from 0.5:1 to 0.9:1. Preferably the thickness ratio is in the range of from 0.7:1 to 0.8:1.

Alternatively, After the coating composition has been applied to the microporous sheet and dried to form the coating, the coated microporous sheet may be compressed to permanently reduce the thickness thereof so that the thickness ratio is in the range of from 0.5:1 to 0.9:1. Preferably the thickness ratio is in the range of from 0.7:1 to 0.8:1.

As yet another alternative, the microporous sheet may be compressed to permanently reduce the thickness thereof before application of the coating composition. The coating composition is thereafter applied to the permanently deformed microporous sheet and dried to form the coating. In such cases the microporous material sheet is compressed such that the thickness ratio is in the range of from 0.5:1 to 0.9:1. Preferably the thickness ratio is in the range of from 0.7:1 to 0.8:1.

As used throughout this specification the thickness ratio is the ratio of the thickness of the microporous material sheet after permanent deformation due to compression divided by the thickness of the microporous material sheet before compression.

Compression may be accomplished by any conventional compression technique. Examples include compression in a platen press and compression by one or more sets of calender rolls. It should be noted that calendering employed before extraction of the processing plasticizer during manufacture of the microporous sheet is not compression of a microporous material sheet as is contemplated here.

The temperature at which compression may be accomplished may vary widely. Usually compression is accomplished at temperatures in the range of from 15° C. to 125° C. In many instances compression is accomplished at temperatures in the range of from 20° C. to 120° C. Preferably compression is accomplished at temperatures in the range of from 40° C. to 115° C. Usually calendering at higher temperatures favors surfaces of higher gloss.

The surfaces of the platens or rolls may be varied to achieve the desired finish on the finished product. Usually the surfaces of the platens or rolls are polished steel or chrome plated steel when a glossy finish is desired. Platens or rolls with rougher surfaces may be used when a matte finish or other non-glossy finish is desired.

The finish is also affected by the temperature at which compression is accomplished. The effect of temperature on the surface finish in any particular instance may be quickly ascertained by a few routine tests.

From what has been said above in respect of compressing the microporous material sheet, either before or after coating, several further embodiments are manifest:

In artificial paper having generally opposing sides produced by compressing a sheet of microporous material having generally opposing sides to permanently reduce the thickness thereof so that the thickness ratio is in the range of from 0.5:1 to 0.9:1, another embodiment of the invention is the improvement wherein the microporous material on a coating-free, printing ink-free, impregnant-free basis prior to compression comprises: (1) a matrix consisting essentially of substantially water-insoluble thermoplastic organic polymer, (2) finely divided substantially water-insoluble filler particles, the filler particles being distributed throughout the matrix and constituting from 40 to 90 percent by weight of the microporous material, and (3) a network of interconnecting pores communicating substantially throughout the microporous material, the pores constituting from 35 to 95 percent by volume of the microporous material.

Yet another embodiment of the invention is an article comprising: (a) a sheet of artificial paper having generally opposing sides, the artificial paper having been produced by compressing a sheet of microporous material having generally opposing sides to permanently reduce the thickness thereof so that the thickness ratio is in the range of from 0.5:1 to 0.9:1, wherein the microporous material on a coating-free, printing ink-free, impregnant-free basis prior to compression comprises: (1) a matrix consisting essentially of substantially water-insoluble thermoplastic organic polymer, (2) finely divided substantially water-insoluble filler particles, the filler particles being distributed throughout the matrix and constituting from 40 to 90 percent by weight of the microporous material, and (3) a network of interconnecting pores communicating substantially throughout the microporous material, the pores constituting from 35 to 95 percent by volume of the microporous material; and (b) an ink-receptive layer joined to at least one side of the sheet of artificial paper.

The invention is further described in conjunction with the following examples which are to be considered illustrative rather than limiting.

### Preparation of Roll Stock

The preparation of microporous materials is illustrated by the following seven descriptive formulations. Processing oil was used as the processing plasticizer. The material identified as SAA is an organic surface active agent. Silica, polymer, lubricant, titanium dioxide, antioxidant, and, when used, organic surface active agent, in the amounts specified in Table 2 were placed in a high intensity mixer and mixed at high speed for 6 minutes. The processing oil needed to formulate the batch was pumped into the mixer over a period of from 3 to 5 minutes with high speed agitation. After completion of the processing oil addition, a 6 minute high speed mix period was used to complete the distribution of the processing oil uniformly throughout the mixture.

The mixture was conveyed to a feeder hopper and feed to a twin screw extruder by a variable rate screw feeder. Additional processing oil was added via metering pump which injected the oil downstream of the feed port in a “low pressure” region of the screw. The extruder mixed and melted the formulation and extruded it through a slot die having a slot width of 196 centimeters and a slot thickness adjustable in the range of from 0.15 centimeter to 0.30 centimeter. The extruded sheet was then calendered. A description of one type of calender that may be used may be found in the U.S. Pat. No. 4,734,229, including the structures of the devices and their modes of operation. Other calenders of different design may alternatively be used; such calenders and their modes of operation are well known in the art. The hot, calendered sheet was then passed around a chill roll to cool the sheet. The rough edges of the cooled calendered sheet were trimmed by rotary knives to the desired width.

The oil filled sheet was conveyed to the extractor unit where it was contacted by both liquid and vaporized 1,1,2-trichloroethylene (TCE). The sheet was transported over a series of rollers in a serpentine fashion to provide multiple, sequential vapor/liquid/vapor contacts. The extraction liquid in the sump was maintained at a temperature of from 65 to 88° C. Overflow from the sump of the TCE extractor was returned to a still which recovered the TCE and the processing oil for reuse in the process. The bulk of the TCE was extracted from the sheet by steam as the sheet was passed through a second extractor unit. A description of these types of extractors may be found in U.S. Pat. No. 4,648,417, including especially the structures of the devices and their modes of operation. The sheet was dried by radiant heat and convective air flow in a drying oven. The dried sheet was wound on cores to provide roll stock for further processing. The formulations and nominal thicknesses of the microporous sheets are shown in Table 2.

TABLE 2

| Formulation No. | 1 | 2 | 3 | 4 | 5 | 6 | 7 |
|---|---|---|---|---|---|---|---|
| UHMWPE (1), kg | 35.0 | 38.9 | 42.8 | 44.4 | 52.8 | 0 | 0 |
| UHMWPE (2), kg | 0 | 0 | 0 | 0 | 0 | 54.4 | 54.4 |
| HDPE (3), kg | 42.8 | 38.9 | 35.0 | 29.6 | 31.0 | 23.3 | 23.3 |
| Silica (4), kg | 159.1 | 159.1 | 159.1 | 159.1 | 159.1 | 159.1 | 159.1 |
| TiO₂ (5), kg | 6.18 | 6.18 | 6.18 | 6.18 | 6.18 | 6.18 | 6.18 |
| Antioxidant (6), kg | 0 | 0 | 0.82 | 0.73 | 0.31 | 0 | 0 |
| Antioxidant (7), kg | 0.45 | 0.45 | 0 | 0 | 0 | 0.45 | 0.45 |
| SAA (8), kg | 0.68 | 0.68 | 0.68 | 0.68 | 0.68 | 0.68 | 0 |
| Lubricant (9), kg | 1.59 | 1.59 | 1.59 | 1.59 | 1.59 | 1.59 | 1.59 |
| Process Oil (10), kg | | | | | | | |
| Added to Mixer | 249.5 | 249.5 | 249.5 | 249.5 | 249.5 | 249.5 | 249.5 |
| Added at Extruder | 123.8 | 158.4 | 178.4 | 174.8 | 150.7 | 186.3 | 186.3 |
| NT (11), mm | 0.254 | 0.254 | 0.254 | 0.254 | 0.254 | 0.356 | 0.356 |

Notes:
(1) UHMWPE = GUR 4132 Ultra High Molecular Weight Polyethylene, Hoechst-Celanese Corp.
(2) UHMWPE = GUR 4122 Ultra High Molecular Weight Polyethylene, Hoechst-Celanese Corp.
(3) HDPE = Fina 1288 High Density Polyethylene, Fina, Inc.
(4) Hi-Sil ® SBG Precipitated Silica, PPG Industries, Inc.
(5) TiO₂ = Ti-Pure ® R-960 Titanium Dioxide, DuPont.
(6) Cyanox ® 1790 Antioxidant, Cytec Corp.
(7) Ronotec ®201 Antioxidant, Hoffmann-La Roche, Inc.
(8) SAA = Larostat ® HTS-905S 60 wt % Octyl-dimethyl-2-hydroxyethyl quaternary ammonium methane sulfonate on 40 wt % Hi-Sil ® ABS Precipitated Silica, PPG Industries, Inc.
(9) Petrac ® CZ-81 Lubricant, Synpro Corp.
(10) Tufflo ® 6056 Oil, Lyondell Petroleum Corp.
(11) NT = Nominal Thickness (10 mils = 0.254 mm; 14 mils = 0.3556 mm).

In the Examples, the following general procedures and conditions were observed:

### Calendering Microporous Sheets

A Beloit Wheeler Model 700 Pilot Supercalender equipped with steel rolls was used to calender 21.6 centimeter×28.0 centimeter sheets of microporous material at 175 kilonewtons per linear meter.

### Preparation of Colloidal Dispersion

With stirring, 248 grams of aluminum tri-sec-butoxide [CAS 2269-22-9] was added to 2 liters of water at 70° C. in a glass container. To this mixture 6 grams of 60 percent concentrated nitric acid was added. The reaction mixture was stirred for 15 minutes on a hot plate. The glass container containing the reaction mixture was then sealed with a lid and placed in an oven at 95° C. for 2 days. During the two-day period in the oven the precipitate in the reaction mixture was peptized. The resulting colloidal dispersion was concentrated in an unsealed container to 600 grams by boiling to produce a colloidal dispersion (sol) containing 10 percent by weight colloidal hydrated aluminum oxide.

### Preparation of Coating Composition

One gram of poly(vinyl alcohol)(Airvol® 205S, Air Products and Chemicals, Inc.) and 2 grams of hydroxypropylcellulose (average molecular weight 370,000; Aldrich Chemical Company, Inc.) were added to 100 grams of the 10 percent hydrated aluminum oxide colloidal dispersion described above. The mixture was stirred until it had the appearance of a clear solution and then it was filtered through a 100 mesh screen (39.37 meshes per centimeter; 100 meshes per inch) to produce a coating composition.

### Coating Procedure

Calendered sheets of microporous material were coated by distributing the above coating composition across the top of a sheet of calendered microporous material and then drawing the coating down using a #18 Meyer wire-wound rod. The coated sheets were then air dried. The resulting coating is between 9 and 15 grams per square meter, dry coating weight The preferred coating weight is 12 grams per square meter, dry coating weight. Uncalendered microporous material was coated in like manner as a control.

### EXAMPLE 1

A sheet of microporous material having a nominal thickness of 0.356 millimeter was calendered for 5 passes at a roll temperature of 66° C. to produce calendered sheet having a nominal thickness of 0.254 millimeter. The calendered sheet was coated and the coating was air dried. The dry sheet was then calendered once.

### EXAMPLE 2

A sheet of microporous material having a nominal thickness of 0.356 millimeter was calendered for 5 passes at a roll temperature of 66° C. to produce calendered sheet having a nominal thickness of 0.254 millimeter. The calendered sheet was coated and the coating was air dried. The dry sheet was not thereafter calendered.

### EXAMPLE 3

A sheet of microporous material having a nominal thickness of 0.356 millimeter was calendered for 5 passes at using rolls at ambient room temperature to produce calendered sheet having a nominal thickness of 0.254 millimeter. The calendered sheet was coated and the coating was air dried. The dry sheet was not thereafter calendered.

### EXAMPLE 4

A sheet of microporous material of Formulation 5 having a nominal thickness of 0.254 millimeter was calendered for 5 passes at a roll temperature of 66° C. to produce calendered sheet having a nominal thickness of 0.203 millimeter. The calendered sheet was coated and the coating was air dried. The dry sheet was not thereafter calendered.

### EXAMPLE 5

An uncalendered sheet of microporous material having a nominal thickness of 0.356 millimeter was coated and the coating was air dried. The dry sheet was not thereafter calendered.

The sheets of the above Examples were tested for 75° Gloss according to the method of TAPPI Standard T480 om 85. The sheets were printed on a Hewlett-Packard 310 Ink Jet Printer and the print density was measured using The Answer II Reflection Densitometer RD-922, Macbeth Division of Kollnorgan Instruments Corporation, New Windsor N.Y., in accordance with the accompanying operating manual. The results are shown in Table 3:

TABLE 3

| Example | 1 | 2 | 3 | 4 | 5 |
|---|---|---|---|---|---|
| Visual | | | | | |
| Appearance | Very High | High | Satin | High | Matte |
| | Gloss | Gloss | Finish | Gloss | Finish |
| 75° Gloss | 90 | 80 | 55 | 80 | 24 |
| Print Density | | | | | |
| Black | 1.62 | 1.58 | 1.36 | 1.58 | 1.44 |
| Yellow | 0.96 | 0.97 | 0.97 | 0.96 | 0.90 |
| Cyan | 2.07 | 2.13 | 1.68 | 2.15 | 1.74 |
| Magenta | 1.20 | 1.25 | 1.14 | 1.27 | 1.08 |

Although the present invention has been described with reference to specific details of certain embodiments thereof, it is not intended that such details should be regarded as limitations upon the scope of the invention except insofar as they are included in the accompanying claims.

1. An article comprising:
(a) a sheet of microporous material having generally opposing sides, the microporous material on a coating-free, printing ink-free, and impregnant-free basis comprising:
(1) a matrix consisting essentially of substantially water-insoluble thermoplastic organic polymer,
(2) finely divided substantially water-insoluble filler particles, the filler particles being distributed throughout the matrix and constituting from 40 to 90 percent by weight of the microporous material, and
(3) a network of interconnecting pores communicating substantially throughout the microporous material, the pores constituting from 35 to 95 percent by volume of the microporous material; and
(b) an ink-receptive layer joined to at least one side of the microporous material, the ink receptive layer comprising hydrated aluminum oxide.

2. The article of claim 1 wherein the substantially water-insoluble thermoplastic organic polymer comprises ultrahigh molecular weight polyethylene.

3. The article of claim 1 wherein the finely divided substantially water-insoluble filler particles comprise precipitated silica particles.

4. The article of claim 1 wherein the ink-receptive layer also comprises water-soluble binder.

5. The article of claim 4 wherein the water-soluble binder comprises water-soluble cellulose ether.

6. The article of claim 5 wherein the water-soluble cellulose ether is water-soluble hydroxypropyl cellulose.

7. The article of claim 6 wherein the water-soluble binder also comprises water-soluble poly(vinyl alcohol).

8. The article of claim 1 wherein:
(a) the substantially water-insoluble thermoplastic organic polymer comprises ultrahigh molecular weight polyethylene;
(b) the finely divided substantially water-insoluble filler particles comprise precipitated silica particles; and
(c) the ink-receptive layer also comprises water-soluble binder which comprises water-soluble hydroxypropyl cellulose and water-soluble poly(vinyl alcohol).

9. An article comprising:
(a) a sheet of microporous material having generally opposing sides, the microporous material on a coating-free, printing ink-free, and impregnant-free basis comprising:
(1) a matrix consisting essentially of substantially water-insoluble thermoplastic organic polymer,
(2) finely divided substantially water-insoluble filler particles, the filler particles being distributed throughout the matrix and constituting from 40 to 90 percent by weight of the microporous material, and
(3) a network of interconnecting pores communicating substantially throughout the microporous material, the pores constituting from 35 to 95 percent by volume of the microporous material; and
(b) an ink-receptive layer joined to at least one side of the microporous material, the ink receptive layer comprising water soluble binder.

10. The article of claim 9 wherein the substantially water-insoluble thermoplastic organic polymer comprises ultrahigh molecular weight polyethylene.

11. The article of claim 9 wherein the finely divided substantially water-insoluble filler particles comprise precipitated silica particles.

12. The article of claim 11 wherein the water-soluble binder comprises water-soluble cellulose ether.

13. The article of claim 12 wherein the water-soluble cellulose ether is water-soluble hydroxypropyl cellulose.

14. The article of claim 13 wherein the water-soluble binder also comprises water-soluble poly(vinyl alcohol).

15. An article comprising:
(a) a sheet of artificial paper having generally opposing sides, the artificial paper having been produced by compressing a sheet of microporous material having generally opposing sides to permanently reduce the thickness thereof so that the thickness ratio is in the range of from 0.5:1 to 0.9:1, wherein the microporous material on a coating-free, printing ink-free, impregnant-free basis prior to compression comprises:
(1) a matrix consisting essentially of substantially water-insoluble thermoplastic organic polymer,
(2) finely divided substantially water-insoluble filler particles, the filler particles being distributed throughout the matrix and constituting from 40 to 90 percent by weight of the microporous material, and
(3) a network of interconnecting pores communicating substantially throughout the microporous material, the pores constituting from 35 to 95 percent by volume of the microporous material; and
(b) an ink-receptive layer joined to at least one side of the sheet of artificial paper.

16. The article of claim 15 wherein the ink receptive layer comprises hydrated aluminum oxide.

17. The article of claim 15 wherein the substantially water-insoluble thermoplastic organic polymer comprises ultrahigh molecular weight polyethylene.

18. The article of claim 15 wherein the finely divided substantially water-insoluble filler particles comprise precipitated silica particles.

19. The article of claim 15 wherein the ink-receptive layer also comprises water-soluble binder.

20. The article of claim 19 wherein the water-soluble binder comprises water-soluble cellulose ether.

21. The article of claim 20 wherein the water-soluble cellulose ether is water-soluble hydroxypropyl cellulose.

22. The article of claim 21 wherein the water-soluble binder also comprises water-soluble poly(vinyl alcohol).

23. The article of claim 15 wherein:
(a) the substantially water-insoluble thermoplastic organic polymer comprises ultrahigh molecular weight polyethylene;
(b) the finely divided substantially water-insoluble filler particles comprise precipitated silica particles; and
(c) the ink-receptive layer also comprises water-soluble binder which comprises water-soluble hydroxypropyl cellulose and water-soluble poly(vinyl alcohol).

24. The article of claim 23 wherein the thickness ratio is in the range of from 0.7:1 to 0.8:1

25. In artificial paper having generally opposing sides produced by compressing a sheet of microporous material having generally opposing sides to permanently reduce the thickness thereof so that the thickness ratio is in the range of from 0.5:1 to 0.9:1, the improvement wherein the microporous material on a coating-free, printing ink-free, impregnant-free basis prior to compression comprises:
(1) a matrix consisting essentially of substantially water-insoluble thermoplastic organic polymer,
(2) finely divided substantially water-insoluble filler particles, the filler particles being distributed throughout the matrix and constituting from 40 to 90 percent by weight of the microporous material, and
(3) a network of interconnecting pores communicating substantially throughout the microporous material, the pores constituting from 35 to 95 percent by volume of the microporous material.

26. The artificial paper of claim 25 wherein the substantially water-insoluble thermoplastic organic polymer comprises ultrahigh molecular weight polyethylene.

27. The artificial paper of claim 25 wherein the finely divided substantially water-insoluble filler particles comprise precipitated silica particles.

28. The article of claim 25 wherein the thickness ratio is in the range of from 0.7:1 to 0.8:1.

29. The article of claim 25 wherein:
(a) the substantially water-insoluble thermoplastic organic polymer comprises ultrahigh molecular weight polyethylene;
(b) the finely divided substantially water-insoluble filler particles comprise precipitated silica particles; and
(c) the thickness ratio is in the range of from 0.7:1 to 0.8:1.
